(19) United States
(12) Patent Application Publication
(10) Pub. No.: US 2013/0050154 A1
(43) Pub. Date: Feb. 28, 2013

(54) STYLUS FOR USE WITH TOUCH SCREEN COMPUTING DEVICE

(71) Applicants: Benjamin T. Guy, Nashville, TN (US); Richard Hoehn, Brentwood, TN (US); Aaron S. Shepard, Smyrna, TN (US)

(72) Inventors: Benjamin T. Guy, Nashville, TN (US); Richard Hoehn, Brentwood, TN (US); Aaron S. Shepard, Smyrna, TN (US)

(21) Appl. No.: 13/538,298

(22) Filed: Jun. 29, 2012

Related U.S. Application Data
(60) Provisional application No. 61/502,491, filed on Jun. 29, 2011.

(51) Int. Cl. G06F 3/033; G09G 5/00

(52) U.S. Cl. 345/179; 345/156

(57) ABSTRACT

A pen or stylus for use with a touch screen computer. The stylus has a conductive body and a conductive tip. A relay in the stylus is used to selectively electrically connect the conductive stylus body, which is coupled to the hand of the, user, to the conductive tip. A series of the pulses are produced by the stylus that are detected by software on the computer. The detected pulses can be used to differentiate between a finger touch and a stylus touch and to transfer data or commands from the stylus to the touch screen device.

### CROSS-REFERENCES TO RELATED APPLICATIONS

The present Utility Patent Application is based upon and claims priority from co-pending U.S. Provisional Patent Application No. 61/502,491 filed Jun. 29, 2011.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

Data is typically entered into a touch screen device by touching various icons on the touch screen. Other prior art technologies for interacting with touch screen devices such as “multi-touch” and “gesturing” allow different commands to be entered based upon the detected presence of an object on the touch screen. However, these prior technologies for use with computer touch screens do not receive commands or data by differentiating between different types of detected objects or stimulus. Rather, they rely primarily on the position of the object detected contacting the touch screen. Therefore, what is needed is an improved device and method for entering data on a touch screen device.

### BRIEF SUMMARY OF THE INVENTION

An embodiment of the present invention is directed toward a stylus for use with a touch screen device. The stylus includes a conductive housing, a conductive tip and a switch that connects the conductive housing to the conductive tip. The conductive housing preferably is a conductive plastic and the conductive tip is preferably a conductive rubber. A microcontroller controls the switch such that conductive housing is alternatively connected to, and disconnected from, the conductive tip. The microcontroller preferably operates the switch at a rate of 20 Hz. A motion sensor that is monitored by the microcontroller detects motion of the stylus.

Another embodiment of the present invention is directed toward an input device for interacting with a touch screen device having a touch screen. The input device includes a first conductive portion that contacts the touch screen and a second conductive portion that contacts a user's hand. The first conductive portion further is preferably a pen-shaped housing and the second conductive portion a rubber conductive tip. A relay controlled by a microcontroller operates to selectively connect and disconnect the first conductive portion and the second conductive portion. Application software on the touch screen device detects rapid changes in contact with the touch screen. An accelerometer that is monitored by the microcontroller detects motion of the input device. A boost converter power supply is used to power the input device.

Yet another embodiment of the present invention is directed toward a method of interacting with a device having a touch screen. The method begins with the step of contacting the touch screen with a conductor. The conductor is them selectively electrically connected to a finger of a person. A microcontroller is preferably used to control the electrical connecting of the conductor to the finger. The movement of the conductor is preferably detected and the conductor selectively connected to the finger based upon the detected movement.

### BRIEF DESCRIPTION OF THE SEVERAL VIEWS OF THE DRAWINGS

FIG. 1 is an illustration of a stylus in accordance with an embodiment of the present invention;

FIG. 2 is a block diagram of the hardware elements of an embodiment of the present invention;

FIG. 3 is a graph of an exemplary pulse for use with an embodiment of the present invention; and

FIG. 4 is an illustration of a conductive tip for use with an embodiment of the present invention.

### DETAILED DESCRIPTION OF THE INVENTION

The above discussed problems in the prior art are addressed by the creation of a stylus that indicates it's presence by creating pulsed touch events. These pulsed touch events on the touch screen of a tablet computer can be recognized by software running on the touch screen device by as originating from a unique input source and representing a unique command or input. This is achieved through a simple but effective hardware implementation that mimics a very rapid touching and removing (tapping) of a finger on the touch screen. The rapid and controlled nature of the pulsing allows software in the computer to distinguish between the contact of the stylus and a human finger. These rapid simulated taps can be used to transmit data or commands from the stylus to the touch screen device.

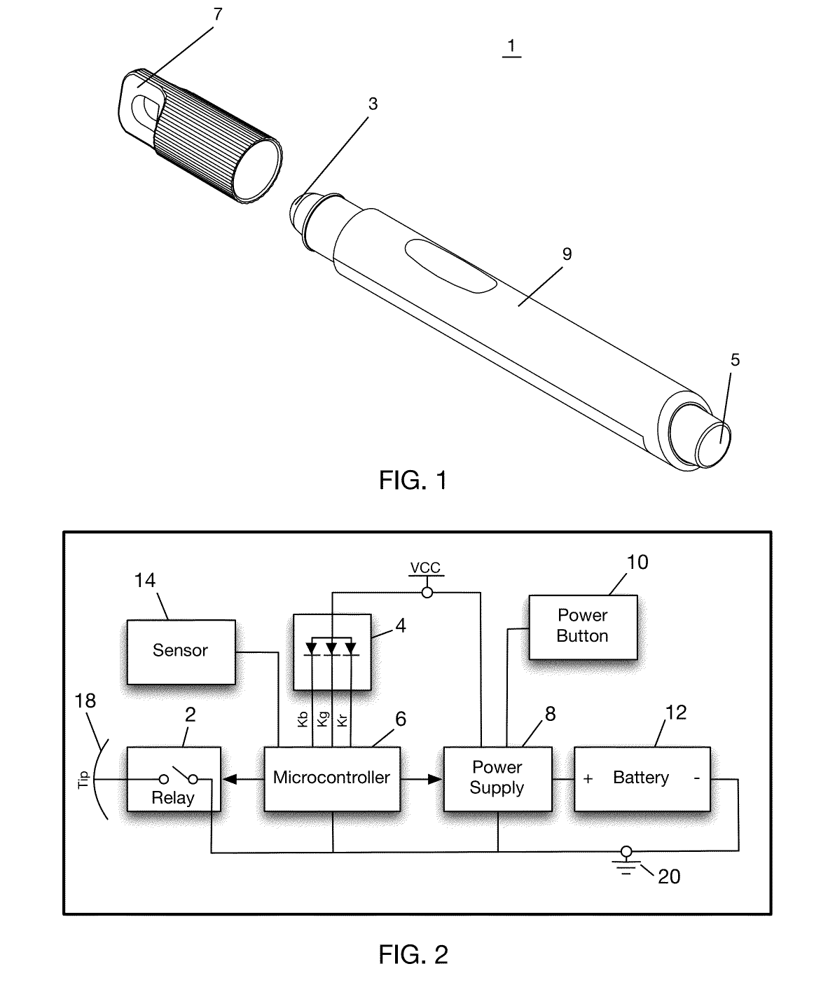

Referring now to FIG. 1, an illustration of a stylus 1 constructed in accordance with an embodiment of the present invention is shown. The stylus 1 or pen-like device uses pulsed switch closures to create a repetitive “tapping” or “pulsing” input on the touch screen of a touch screen device such as a tablet computer. The pulsed contact closures between the conductive housing 9 of the stylus 1 and the conductive rubber tip 3 on the end of the stylus 1 are coupled to the touch screen by placing the conductive rubber tip 3 in contact with the touch screen. A cap 7 protects the conductive rubber tip 3 when the stylus 1 is not in use. A user input 5 on the end of the stylus 1 is used to turn the stylus on an off and switch between operating modes. The touch screen computer detects the pulses and uses the pulsed input to differentiate between contact initiated by human fingers (non-pulsed input) and the stylus (pulsed input). This is useful in any situation where the computer needs to differentiate between stylus and finger touch events. In addition, variations in the pulses can be used to transmit digital commands or data from the pen to the touch screen device.

The stylus 1 produces pulsed touch events which are coupled to the touch screen by placing the conductive tip 3 in contact with the touch screen of the computer where they are detected and interpreted by device or application software residing on the touch screen computer.

Referring now to FIG. 2, a block diagram of the hardware elements of an embodiment of the present invention is shown. The hardware elements include and an electronic relay or switch 2, set of indicators 4, microcontroller 6, a power supply unit 8, on/off power button 10, battery 12, sensor 14 and conductive tip 18.

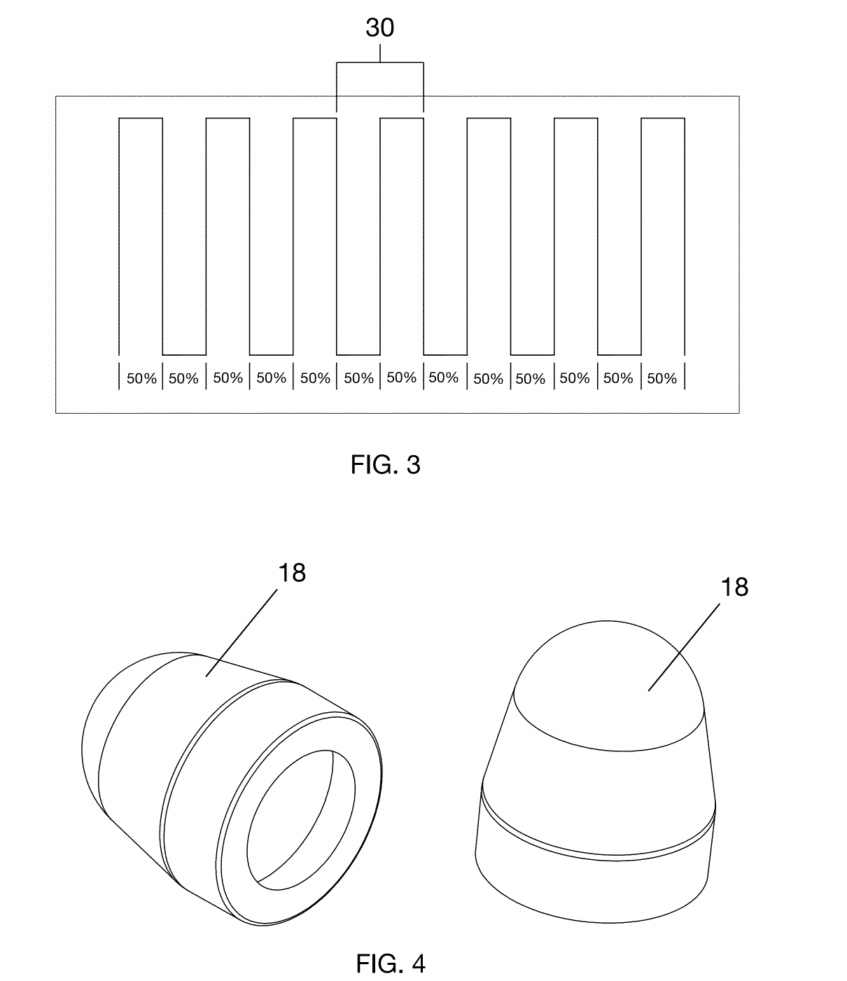

The relay or switch 2 acts as a simple mechanical switch. A graph of an exemplary pulse for use with an embodiment of the present invention is shown in FIG. 3. The on/off transition time 30 of the relay is 1/20 of a second, or 20 Hz with an even 50% on, 50% off duty cycle. The rate, duration, and duty cycle. (20 Hz) of the switch/relay 2 closures are under the control of the microcontroller 6 and can be varied as needed for different applications and to transmit data. The relay circuit 2 is designed to produce a very high impedance or open circuit when open or off, and a low impedance or short circuit connection to ground 20 when closed or on. In the preferred embodiment, ground 20 is the user's hand and accomplished by closing the relay and electrically connecting the conductive tip of the stylus to the user's hand through the conductive housing of the stylus. The conductive tip is then interpreted as a pulsing finger touch by the touch screen computer.

The preferred embodiment of the present invention uses a three (3) color (RGB) LED system as indicators 4. The primary function of the LED indicators is to provide visual feedback to the user regarding the operation of the stylus. In the preferred embodiment, the three LED colors represent on, off and communicating. In addition, the LED system 4 can also be used to indicate individual ON and OFF transitions for technical support diagnostics.

The microcontroller 6 is used to control the various functions of the pulsing stylus. The microcontroller 6 controls the relay 2 pulsing, LED 4 color, power/function button 10 read, power supply 8 latching and power-down conditions, and diagnostics for the stylus electronics. A sensor 14 such as an accelerometer or motion sensor can be included in the stylus to detect movement of the stylus. The microcontroller 6 monitors the sensor 14 to detect movement of the stylus and generate pulsed outputs based upon the sensed motion that are applied to the conductive tip. The power/function button 10 is used to cycle between various operating states of the stylus. For example, one click activates the stylus, a second click initiates pulsing and a third click alters the pulsing sequence. Additional user inputs that are monitored by the microcontroller 6 may be provided on the stylus if desired to allow additional modes or commands.

The power supply unit 8 is preferably a switch mode power supply that uses a boost converter topology. Both the microcontroller 6 and the power button 10 control the enabling (on-off state) of the power supply unit 8. The battery may be rechargeable if desired.

In order to connect the human body's capacitance to the touch screen of a tablet computer, the stylus has a conductive plastic body 9 as shown in FIG. 1 that is internally wired through the relay 2 so that it can be selectively electrically connected to the conductive rubber tip 18 of the pen. As shown in FIG. 4, the conductive rubber tip 18 is preferably a hollow shape that fits over a conductive projection on the end of the stylus housing. This allows the conductive tip 18 to be easily replaced if damaged. The pen body and conductive rubber tip 18 connections are controlled by the relay 2 that preferably connects the body and conductive rubber tip with each other during operation at a speed of 20 Hz. However, the pulse rate, can be varied as desired.

Although there have been described particular embodiments of the present invention of a new and useful STYLUS FOR USE WITH TOUCH SCREEN COMPUTING DEVICE, it is not intended that such references be construed as limitations upon the scope of this invention except as set forth in the following claims.

What is claimed is:

1. A stylus for use with a touch screen device, said stylus comprising:
a conductive housing;
a conductive tip; and
a switch that connects said conductive housing to said conductive tip.

2. The stylus of claim 1 wherein said conductive housing further comprises a conductive plastic.

3. The stylus of claim 1 wherein said conductive tip further comprises a conductive rubber tip.

4. The stylus of claim 1 further comprising a microcontroller that controls said switch such that said conductive housing is alternatively connected to, and disconnected from, said conductive tip.

5. The stylus of claim 4 wherein said microcontroller operates said switch at a rate of 20 Hz.

6. The stylus of claim 1 further comprising a motion sensor that detects motion of said stylus.

7. An input device for interacting with a touch screen device having a touch screen; said input device comprising:
a first conductive portion that contacts said touch screen;
a second conductive portion that contacts a user's hand; and
a relay that operates to selectively connect and disconnect said first conductive portion and said second conductive portion.

8. The input device of claim 7 further comprising application software on said touch screen device that detects rapid changes in contact with said touch screen.

9. The input device of claim 7 wherein said first conductive portion further comprises a pen-shaped housing.

10. The input device of claim 7 wherein said second conductive portion further comprises a rubber conductive tip.

11. The input device of claim 7 further comprising a microcontroller.

12. The input device of claim 7 further comprising an accelerometer.

13. The input device of claim 7 further comprising a boost converter power supply.

14. A method of interacting with a device having a touch screen, said method comprising the steps of:
contacting said touch screen with a conductor; and
selectively electrically connecting said conductor to a finger of a person.

15. The method of claim 14 further comprising the step of using a microcontroller to control said electrical connecting of said conductor to said finger.

17. The method of claim 14 further comprising the step of detecting movement of said conductor and selectively connecting said conductor to said finger based upon said detected movement.
